(19) United States
(12) Patent Application Publication
(10) Pub. No.: US 2021/0256258 A1
(43) Pub. Date: Aug. 19, 2021

(54) METHOD, APPARATUS, AND COMPUTER PROGRAM FOR EXTRACTING REPRESENTATIVE CHARACTERISTICS OF OBJECT IN IMAGE

(71) Applicant: ODD CONCEPTS INC., Seoul (KR)

(72) Inventor: Jae Yun YEO, Gyeonggi-do (KR)

(21) Appl. No.: 17/055,990

(22) PCT Filed: May 17, 2019
(86) PCT No.: PCT/KR2019/005935

§ 371 Date: Nov. 16, 2020

(30) Foreign Application Priority Data
May 18, 2018 (KR) 10-2018-0056826

(51) Int. Cl. G06K 9/00; G06K 9/62; G06N 3/08; G06N 3/04

(52) U.S. Cl. CPC G06K 9/00664; G06K 9/6232; G06N 3/0454; G06N 3/08; G06K 9/6256

(57) ABSTRACT

Provided is a method and an apparatus for extracting a representative feature of an object. The method includes receiving a query image, generating a saliency map for extracting an inner region of an object corresponding to a specific product included in the query image by applying the query image to a first learning model that is trained on a specific product, applying the saliency map as a weight to a second learning model that is trained for object feature extraction, and extracting feature classification information of the inner region of the object by inputting the query image into the second learning model to which the weight is applied.

### TECHNICAL FIELD

The present disclosure relates to a method and an apparatus for extracting a representative feature of an object, and more particularly, to a method, an apparatus, and a computer program for extracting a representative feature of a product object included in an image.

### BACKGROUND ART

In general, product images include various objects to draw attention and interest to products. For example, in the case of clothing or accessories, an advertising image or a product image are generally captured while a popular commercial model is wearing the clothing or accessories, and this is because an overall atmosphere created by the model, the background, and props can influence the attention and interest to the product.

Therefore, most of the images obtained in search for a certain product generally include a background. As a result, in the case where an image with a high proportion of background is included in a DB, if a search is performed using color as a query, there may be errors, for example, that an image having a background of the same color is output.

In order to reduce such errors, a method for extracting a candidate region using an object detecting model and extracting a feature from the candidate region is used, as disclosed in Korean Patent No. 10-1801846 (Publication Date: Mar. 8, 2017). The related art as described above generates a bounding box 10 for each object as shown in FIG. 1 to extract a feature from the bounding box, and even in this case, a proportion of the background in an entire image is slightly reduced and an error of extracting a background feature from the bounding box as an object feature cannot be completely removed. Therefore, there is a need for a method for accurately extracting a representative feature of an object included in an image with a small amount of computation.

### SUMMARY OF INVENTION

### Technical Problem

An object of the present disclosure is to solve the above-mentioned problems, and to provide a method capable of extracting representative feature of a product included in an image with a small amount of computation.

Another object of the present disclosure is to solve the problem of not accurately extracting a feature of a product in an image due to a background feature included in the image, and to identify a feature of the product quickly compared to a conventional method.

### Solution to Problem

In an aspect of the present disclosure, there is provided a method for extracting a representative feature of an object in an image by a server, the method including receiving a query image, generating a saliency map for extracting an inner region of an object corresponding to a specific product included in the query image, by applying the query image to a first learning model that is trained on a specific product, applying the saliency map as a weight to a second learning model which is trained for object feature extraction, and extracting feature classification information of the inner region of the object, by inputting the query image into the second learning model to which the weight is applied.

In another aspect of the present disclosure, there is provided an apparatus for extracting a representative feature of an object in an image, the apparatus including a communication unit configured to receive a query image, a map generating unit configured to generate a saliency map corresponding to an inner region of an object corresponding to a specific product in the query image, by using a first learning model that is trained on the specific product, a weight applying unit configured to apply the saliency map as a weight to a second learning model that is trained for object feature extraction, and a feature extracting unit configured to extract feature classification information of the inner region of the object by inputting the query image to the second learning model to which the weight is applied.

### Advantageous Effects of Invention

According to the present disclosure as described above, it is possible to extract a representative feature of an object included in an image even with a small amount of computation.

In addition, according to the present disclosure, it is possible to solve the problem of not accurately extracting a feature of an object in an image due to a background feature included in the image, and it is possible to identify a feature of the product quickly compared to a conventional method.

In addition, according to the present disclosure, since only an inner region of an object is used for feature detection, it is possible to remarkably reduce an error occurring in the event of feature detection.

### BRIEF DESCRIPTION OF DRAWINGS

FIG. 1 is a diagram illustrating a method for extracting an object from an image according to a conventional technology.

FIG. 2 is a diagram illustrating a system for extracting a representative feature of an object according to an embodiment of the present disclosure.

FIG. 3 is a block diagram illustrating a configuration of an apparatus for extracting a representative feature of an object according to an embodiment of the present disclosure.

FIG. 4 is a flowchart illustrating a method for extracting a representative feature of an object according to an embodiment of the present disclosure.

FIG. 5 is a flowchart illustrating a method for applying a weight to a saliency map according to an embodiment of the present disclosure.

FIG. 6 is a view for explaining a convolutional neural network.

FIG. 7 is a diagram illustrating an encoder-decoder structure of a learning model according to an embodiment of the present disclosure.

FIG. 8 is a diagram illustrating extraction of a representative feature of an object according to an embodiment of the present disclosure.

### DESCRIPTION OF EMBODIMENTS

The above-described objects, features, and advantages will be described in detail with reference to the accompanying drawings, and accordingly, a person skilled in the art to which the present disclosure belongs can easily implement technical idea of the present disclosure. In the description of the present disclosure, certain detailed explanations of related art are omitted when it is deemed that they may unnecessarily obscure the essence of the present disclosure.

Hereinafter, preferred embodiments of the present disclosure will be described in detail with reference to the accompanying drawings. In the drawings, same reference numerals are used for the same or similar elements, and combinations described in the specification and the claims may be combined in arbitrary way. In addition, unless otherwise defined, a singular element may include one or more elements and a singular element may also include a plurality of elements.

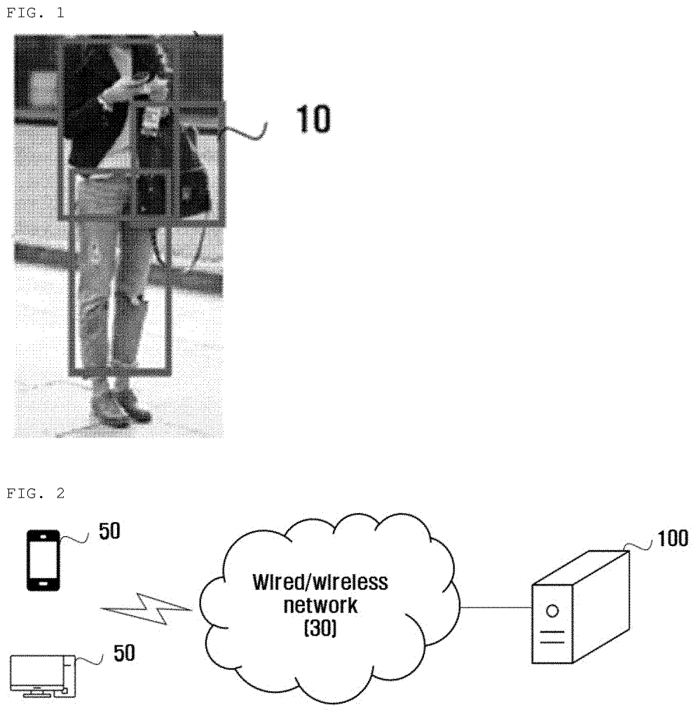

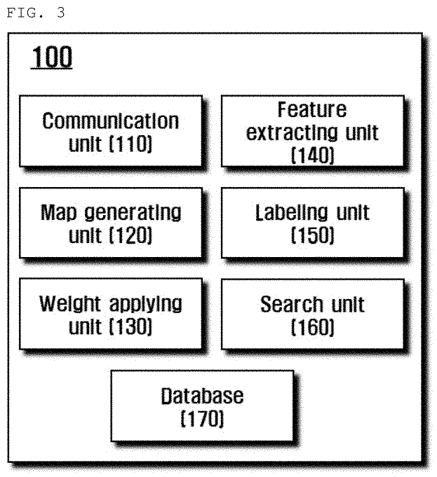

FIG. 2 is a diagram illustrating a representative feature extracting system according to an embodiment of the present disclosure. Referring to FIG. 1, a representative feature extracting system according to an embodiment of the present disclosure includes a terminal 50 and a representative feature extracting apparatus 100. The terminal 50 may transmit a random query image to the representative feature extracting apparatus 100 over a wired/wireless network 30, and the representative feature extracting apparatus 100 may extract a representative feature of a specific product included in the query image and transmit the extracted representative feature to the terminal 50. The query image is an image containing an object (hereinafter referred to as a ‘product’) that can be traded in markets, and while the present disclosure is not limited to a type of product, the present specification will be described mainly about fashion products such as clothes, shoes, bags, etc. for convenience of explanation. Meanwhile, in this specification, a feature of a product may be understood as a feature that can describe the product, such as color, texture, category, pattern, material, or the like, and a representative feature may be understood as a feature that can best represent the product, such as texture, category, pattern, material, or the like.

Referring to FIG. 3, the representative feature extracting apparatus 100 according to an embodiment of the present disclosure includes a communication unit 110, a map generating unit 120, a weight applying unit 130, and a feature extracting unit 140 and may further include a labeling unit 150, a search unit 160, and a database 170.

The communication unit 110 transmits and receives data to and from the terminal 50. For example, the communication unit 110 may receive a query image from the terminal 50 and may transmit a representative feature of the query image, which is extracted from the query image, to the terminal 50. To this end, the communication unit 110 may support a wired communication method, which supports TCP/IP protocol or UDP protocol, and/or a wireless communication method.

The map generating unit 120 may generate a saliency map, which corresponds to an inner region of an object corresponding to a specific product in a query image, using a first learning model that is trained on the specific product. The map generating unit 120 generates the saliency map using a learning model that is trained based on deep learning.

Deep learning is defined as a collection of machine learning algorithms that attempt to achieve high level of abstractions (operations for abstracting key contents or key functions from large amounts of data or complex data) by combining several nonlinear transformation methods. Deep learning may be regarded as a field of machine learning that teaches a person's mindset to a computer using an artificial neural network. Examples of deep learning techniques include Deep Neural Network, Convolutional Deep Neural Networks (CNN), Recurrent Neural Newark (RNN), Deep Belief Networks (DBM), and the like.

According to an embodiment of the present disclosure, a convolutional neural network learning model having an encoder-decoder structure may be used as a first learning model for generating a saliency map.

A convolutional neural network is one type of multilayer perceptron designed to use a minimal preprocessing. The convolutional neural network is composed of one or several convolution layers and general artificial neural network layers on top thereof, and further utilizes a weight and pooling layers. Due to this structure, the convolutional neural network may be able to fully utilize input data of a two-dimensional structure.

The convolutional neural network extracts a feature from an input image by alternately performing convolution and subsampling on the input image. FIG. 6 is a diagram illustrating a structure of a convolutional neural network. Referring to FIG. 6, a convolutional neural network includes multiple convolution layers, multiple subsampling layers (Subsampling layer, Relu layer, Dropout layer, Max-pooling layer), and a Fully-Connected layer. A convolution layer is a layer where convolution is performed on an input image, and the subsampling layer is a layer where a maximum value is extracted locally from the input image to map into a two-dimensional image, thereby making a local area larger and performing subsampling.

The convolution layer has characteristics of converting a large input image into a compact and high-density representation, and such a high-density representation is used to classify an image in a fully connected classifier network.

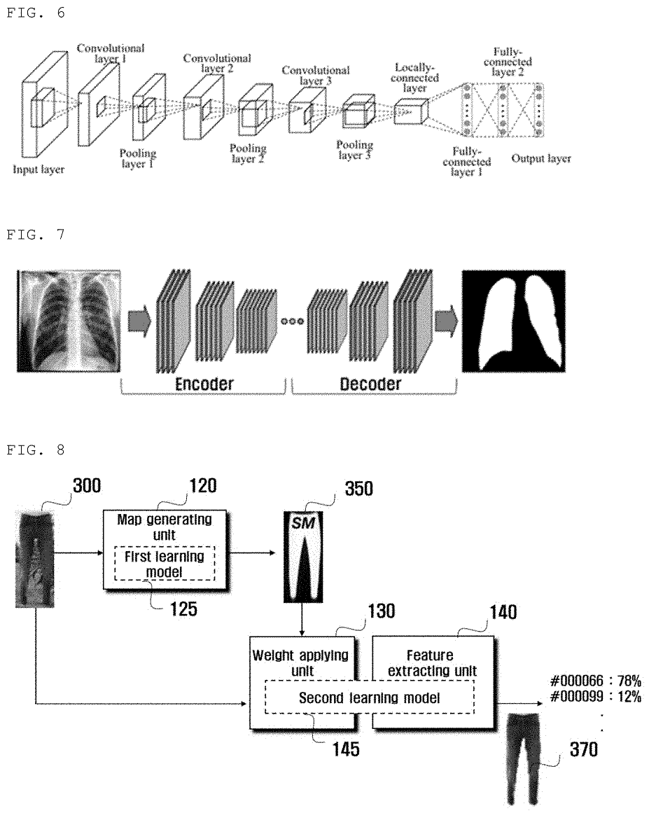

The CNN having the encoder-decoder structure is used for image segmentation, and, as illustrated in FIG. 7, the CNN is composed of an encoder for generating a latent variable representing major features of input data using a convolution layer and a subsampling layer and a decoder for restoring data based on the major features using a deconvolution layer.

The present disclosure uses the encoder-decoder to generate a two-dimensional feature map having the same size as that of an input image, and the feature map having the same size as that of the input image is a saliency map. The saliency map is also referred to as a saliency map or an extruded map, and refers to an image in which a visual region of interest and a background region are segmented and visually displayed. When looking at a certain image, a human focuses more on a specific portion, specifically an area with a big color difference, a big brightness difference, or a strong outbound feature. The saliency map refers to an image of a visual region of interest, which is the first region that attracts a human's attention. Furthermore, a saliency map generated by the map generating unit 120 of the present disclosure corresponds to an inner region of an object corresponding to a specific product in a query image. That is, a background and an object region are separated, and this is a clear difference from a conventional technique that detects an object by extracting only an outbound of the object or by extracting only a bound box containing the object.

Since a saliency map generated by the map generating unit 120 of the present disclosure separates an entire inner region of an object from a background, it is possible to perfectly prevent the object's feature from being mixed with the background's feature (color, texture, pattern, and the like).

An encoder for a saliency map generating model (a first learning model) according to an embodiment of the present disclosure may be generated by combining a convolution layer, a Relu layer, a dropout layer, and a Max-pooling layer, and a decoder thereof may be generated by combining an upsampling layer, a deconvolution layer, a sigmoid layer, and a dropout layer. That is, the saliency map generating model 125 may be understood as a model which has an encoder-decoder structure, and which is trained by a convolutional neural network technique.

The saliency map generating model 125 is pre-trained based on a dataset including an image of a specific product, and, for example, the saliency map generating model 125 illustrated in FIG. 8 may be a model that is pre-trained by using a plurality of images of jeans as a dataset. Meanwhile, since types of product included in a query image are not limited, it should be understood that the saliency map generating model 125 of the present disclosure is pre-trained with a variety of types of product images in order to generate a saliency map of the query image.

Referring back to FIG. 3, the weight applying unit 130 may apply a saliency map as a weight to a second learning model (a feature extracting model) that is trained for object feature extraction. The second learning model is to extract an object feature and may be a model trained by a convolutional neural network technique for image classification or may be trained based on a dataset including one or more product images. For a feature extracting model 145, neural networks composed of convolutions such as AlexNet, VGG, ResNet, Inception, InceptionResNet MobileNet, SqueezeNet DenseNet, and NASNet may be used.

In another embodiment, when the feature extracting model 145 is a model generated to extract color of an inner region of a specific product, the feature extracting model 145 may be a model that is pre-trained based on a dataset that includes a color image, a saliency map, and a color label of the specific product. In addition, an input image may use a color model such as RGB, HSV, and YCbCr.

The weight applying unit 130 may generate a weight filter by converting a size of a saliency map into a size of a first convolution layer (a convolution layer to which a weight is to be applied) included in the feature extracting model 145 and may apply a weight to the feature extracting model 145 by performing element-wise multiplication of the first convolution layer and the weight filter for each channel. As described above, since the feature extracting model 145 is composed of a plurality of convolution layers, the weight applying unit 130 may resize a saliency map so that the size of the saliency map can correspond to a size of any one convolution layer (the first convolution layer) included in the feature extracting model 145. For example, if the size of the convolution layer is 24×24 and the size of the saliency map is 36×36, the size of the saliency map is reduced to 24×24. Next, the feature extracting model 145 may scale a value of each pixel in the resized saliency map. Here, scaling means a standardization operation of multiplying a value by an integer (magnification) to change the value so that a range of the value falls within a predetermined limit. For example, the weight applying unit 130 may scale values of the weight filter to values between 0 and 1 to generate a weight filter having a size of m×n that is equal to a size (m×n) of the first convolution layer. If the first convolution layer is CONV and a weight filter is W_{SM}, the convolution layer to which the weight filter is applied may be calculated as CONV2=CONVXW_{SM}, the second convolution layer which is the first convolution layer with the weight filter applied thereto. This means multiplication between components of the same location, and a region corresponding to an object in a convolution layer, that is, a white region 355 in FIG. 8, may be activated more strongly.

The feature extracting unit 140 inputs a query image into the weighted second learning model and extracts feature classification information of the inner region of the object. When a query image is input to the weighted second learning model, features (color, texture, category), and the like of the query image are extracted by the convolutional neural network used for training the second learning model, and since a weight is applied to the second learning model, it is possible to extract only a feature which highlights the inner region of the object extracted from the saliency map.

That is, with reference to the example of FIG. 8, when a lower body image of a jeans model standing on background of lawn is input as a query image, the map generating unit 120 extracts only an inner region of an object corresponding to the jeans and generates a saliency map 350 in which the inner region and the background are separated. In the saliency map 350, the inner region of the jeans is clearly separated from the background.

The weight applying unit 130 generates a weight filter by converting and scaling a size of the saliency map into a size (m×n) of a convolution layer which is included in the second learning model 145 and to which a weight is to be applied, and then the weight applying unit 130 applies the saliency map to the second learning model 145 as a weight by performing element-wise multiplication between the convolution layer and the saliency map. The feature extracting unit 140 inputs a query image 300 to the second learning model 145 with the weight applied thereto and extracts a feature of a jeans region 370 corresponding to the inner region of the object. When a feature to be extracted is color, classification information of colors constituting the inner region, such as color number 000066: 78% and color number 000099: 12%, may be derived as a result. That is, according to the present disclosure, since it is possible to extract only feature classification information of the inner region of jeans with the background removed, accuracy of the extracted feature is high and it is possible to remarkably reduce errors such as a case where a background feature (for example, green color of grass in the background of the query image 300) is inserted as an object feature.

The labeling unit 150 may set a most probable feature as a representative feature of the object by analyzing feature classification information extracted by the feature extracting unit 140 and may label a query image with the representative feature. The labeled query image may be stored in the database 170, and may be used as a product image for generating a learning model or used for a search.

The search unit 160 may search the database 170 for a product image having the same feature using representative feature of the query image in the feature extracting unit 140. For example, if a representative color of jeans is extracted as “navy blue” and a representative texture thereof is extracted as “denim texture”, the labeling unit 140 may label a query image 300 with the navy blue and the denim and the search unit 160 may search for a product image stored in the database with “navy blue” and “denim.”

One or more query images and/or product images may be stored in the database 170, and a product image stored in the database 170 may be labeled with a representative feature extracted by the above-described method.

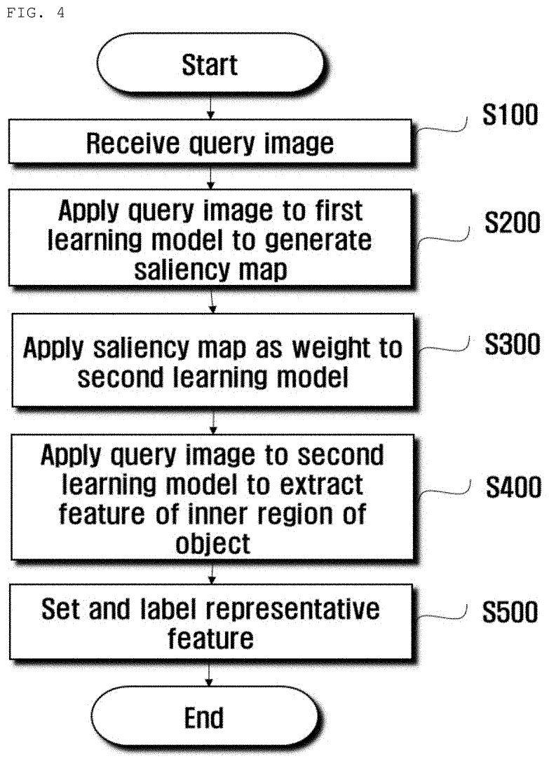

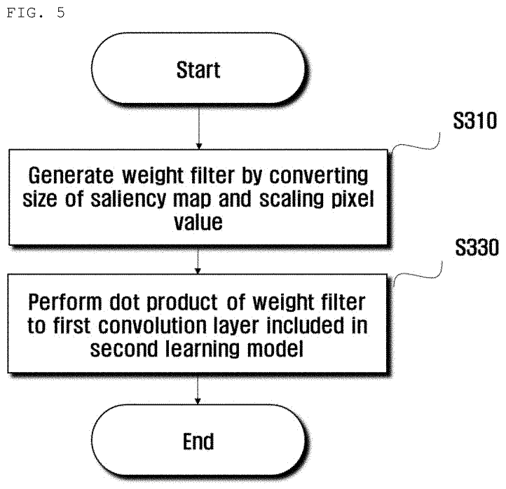

Hereinafter, a representative feature extracting method according to an embodiment of the present disclosure will be described with reference to FIGS. 4 and 5.

Referring to FIG. 4, when a server receives a query image (S100), a saliency map for extracting an inner region of an object corresponding to the specific product included in the query image is generated by applying the query image to a first learning model which is trained on a specific product (S200). The server may apply the saliency map as a weight to a second learning model trained for object feature extraction (S300) and may extract feature classification information of an inner region of an object by inputting the query image to the weighted second learning model (S400).

In step 300, the server may generate the weight filter (S310) by converting a size of the saliency map into a size of a first convolution layer included in the second learning model and scaling a pixel value, and may perform element-wise multiplication of the weight filter with the first convolution layer to which a weight is to be applied (S330).

Meanwhile, the first learning model to be applied to the query image in step 200 may be a model trained by a convolutional neural network technique having an encoder-decoder structure, and the second learning model to which a weight is to be applied in step 300 and which is to be applied to the query image in step 400 may be a model trained by a standard classification convolutional neural network technique.

In another embodiment of the second learning model, the second learning model may be a model that is trained based on an input value in order to learn color of an inner region of a specific product, the input value being at least one of a color image, a saliency map, or a color label of the specific product.

Meanwhile, after step 400, the server may set a most probable feature as a representative feature of the object by analyzing the feature classification information and may label the query image with the representative feature (S500). For example, if the query image contains an object corresponding to a dress and yellow (0.68), white (0.20), black (0.05), and the like with different probabilities are extracted as color information of an inner region of the dress, the server may set yellow with the highest probability as a representative color of the query image and may label the query image “yellow.” If a stripe pattern (0.7), a dot pattern (0.2), and the like are extracted as the feature classification information, the “stripe pattern” may be set as a representative pattern and the “stripe pattern” may be labeled in the query image.

Some embodiments omitted in the present specification are equally applicable to the same subject. The present disclosure is not limited to the above-described embodiment and the accompanying drawings, because various substitutions, modifications, and changes are possible by those skilled in the art without departing from the technical spirit of the present disclosure.

1. A method for extracting a representative feature of an object in an image by a server, the method comprising:
receiving a query image;
generating a saliency map for extracting an inner region of an object corresponding to a specific product included in the query image, by applying the query image to a first learning model that is trained on a specific product;
applying the saliency map as a weight to a second learning model that is trained for object feature extraction; and
extracting feature classification information of the inner region of the object, by inputting the query image into the second learning model to which the weight is applied.

2. The method of claim 1, wherein the applying of the saliency map as the weight comprises:
generating a weight filter by converting and scaling a size of the saliency map to a size of a first convolution layer included in the second learning model; and
performing element-wise multiplication of the weight filter with the first convolution layer.

3. The method of claim 1, wherein the first learning model is a convolutional neural network learning model having an encoder-decoder structure.

4. The method of claim 1, wherein the second learning model is a standard classification Convolutional Neural Network (CNN).

5. The method of claim 1, wherein the second learning model is a convolutional neural network learning model to which at least one of a saliency map of the specific product or a color image of the specific product, saliency map or a color label is applied as a dataset in order to learn color of the inner region of the specific product.

6. The method of claim 1, further comprising:
setting a feature with the highest probability as a representative feature of the object by analyzing the feature classification information; and
labeling the query image with the representative feature.

7. A representative feature extracting application stored in a computer readable medium to implement the methods of claim 1.

8. A representative feature extracting apparatus, comprising:
a communication unit configured to receive a query image;
a map generating unit configured to generate a saliency map corresponding to an inner region of an object corresponding to a specific product in the query image, by using a first learning model that is trained on the specific product;
a weight applying unit configured to apply the saliency map as a weight to a second learning model that is trained for object feature extraction; and
a feature extracting unit configured to extract feature classification information of the inner region of the object by inputting the query image to the second learning model to which the weight is applied.
